(19) United States
(12) Patent Application Publication
(10) Pub. No.: US 2024/0336151 A1
(43) Pub. Date: Oct. 10, 2024

(54) WIRELESS SYSTEM FOR CHARGING AN ELECTRIC BATTERY FOR A MOTOR VEHICLE SUIT ABLE FOR USE IN A CAR PARK

(71) Applicant: NEXANS, Courbevoie (FR)

(72) Inventor: Nicolas LALLOUET, BAINCTHUN (FR)

(21) Appl. No.: 18/290,865

(22) PCT Filed: Jul. 4, 2022
(86) PCT No.: PCT/FR2022/051323

§ 371 Date: Jan. 22, 2024

(30) Foreign Application Priority Data
Jul. 21, 2021 (FR) FR2107872

(51) Int. Cl. B60L 53/122; B60L 53/302

(52) U.S. Cl. CPC B60L 53/122; B60L 53/302

(57) ABSTRACT

The invention relates to several configurations of a system for wirelessly recharging electric batteries of vehicles suitable for equipping a parking area, comprising: several enclosures (2) each comprising a superconducting coil (3), each enclosure (2) being suitable to be positioned at a parking location (1) of the area and comprising an input opening (2a) and an output opening (2b) for the passage of the superconducting coil (3) that it contains; an electric circuit comprising intermediate portions (4) of cable electrically connecting the superconducting coils (3) pairwise so as to form a set of superconducting coils (3) in series, two cable terminations (8), two cable end portions (4′) configured to electrically connect each end of the set to the terminals of an electrical power supply; and a cooling circuit suitable for cooling each superconducting coil using a circulation of a cryogenic fluid.

### TECHNICAL FIELD

The present invention relates generally to the recharging of the electric batteries of motor vehicles, and more specifically a system that makes it possible to do recharges on a large scale, typically on parking areas comprising a plurality of parking locations.

### TECHNOLOGICAL BACKGROUND

The market for electric vehicles is expanding very rapidly. However, the recharging of the electric batteries for motor vehicles is still a technological obstacle. A totally electric vehicle needs several hours to have its battery fully charged.

Recent developments show that the wireless recharging of an electric battery of a motor vehicle could be efficient (90% efficiency) and require only two hours, even less, to recharge a totally electric vehicle.

These developments use a coil of copper wire placed on the ground and passed through by a current to generate an electromagnetic field. This induced electromagnetic field is harvested by another coil situated on the vehicle whose battery is to be charged. However, with the copper wire, the quantity of energy required leads to significant electric losses by Joules effect, and the compactness is limited for this technology, which causes the efficiency of the energy transmission to be limited. Some superconducting coils have been tested in a laboratory to study the wireless energy transmission, but with no vision of a complete system using this technology (See for example C. Utschick, C. Som, J. Šouc, V. Große, F. Gömöry and R. Gross, “Superconducting Wireless Power Transfer Beyond 5 KW at High Power Density for Industrial Applications and Fast Battery Charging”,—IEEE Transactions on Applied Superconductivity, vol. 31, no. 3, pp. 1-10, April 2021, Art no. 5500110, doi: 10.1109/TASC.2021.3056195).

### SUMMARY OF THE INVENTION

The aim of the present invention is to propose different configurations for a recharging system using a plurality of superconducting coils.

The subject of the present invention is a system for wirelessly recharging electric batteries of motor vehicles suitable for equipping a parking area, the recharging system comprising:
a plurality of enclosures each comprising a superconducting coil, each enclosure being configured to be positioned at a parking location of said parking area and comprising an input opening and an output opening for the respective passage of the ends of the superconducting coil that it contains;
an electric circuit comprising intermediate portions of cable electrically connecting the superconducting coils pairwise so as to form a set of superconducting coils in series, two cable terminations, two cable end portions configured to electrically connect each end of the set to the terminals of an electrical power supply, and
a cooling circuit suitable for cooling each superconducting coil using a circulation of a cryogenic fluid.

In possible embodiments, each enclosure of the plurality of enclosures is a cryogenic enclosure.

In these embodiments, the intermediate portions of cable and the cable end portions are superconducting, and each comprise a superconducting conductor contained in a dedicated cryogenic jacket.

The dedicated cryogenic jacket is preferably flexible.

The ends of each intermediate portion of superconducting cable are preferably connected respectively at an output opening and an input opening of two consecutive cryogenic enclosures of the set of superconducting coils in series so as, on the one hand, to ensure a seal-tight continuity in the cryogenic cooling circuit, and, on the other hand, to allow the electrical connection of the superconducting conductor to the ends of the two superconducting coils contained in these two consecutive cryogenic enclosures.

The cooling circuit can comprise the fluidic series connection of the two cable terminations, of the dedicated cryogenic jackets of the two end portions and of the intermediate portions of superconducting cable, and of the cryogenic enclosures.

The cooling circuit can further comprise a cooling system and two transfer lines linking each termination to the cooling system.

In some embodiments, each cryogenic enclosure of the plurality of enclosures comprises an input opening and an output opening for the cryogenic fluid, the cooling circuit comprising the fluidic series connection of a cooling system and of the cryogenic enclosures via cryogenic transfer lines.

The cryogenic transfer lines linking two cryogenic enclosures are then connected between their input opening and their output opening for the respective cryogenic fluid.

In other embodiments, each enclosure of the plurality of enclosures comprises an element made of thermally conductive material, and the cooling circuit comprises a cryogenic transfer line connected to a cryogenic cooling system so as to create a closed loop, the cryogenic transfer line being disposed so as to be in contact with said element of each enclosure to cool each superconducting coil by thermal conduction.

In these embodiments, the intermediate portions of cable and the cable end portions can each comprise a standard electrical conductor.

The ends of each intermediate portion of cable are then preferably connected respectively at an output opening and an input opening of two consecutive enclosures of the set of superconducting coils in series so as to allow the electrical connection of the standard electrical conductor to the ends of the two coils contained in these two consecutive enclosures.

In embodiments, the cryogenic fluid is liquid nitrogen. In other embodiments, the cryogenic fluid is liquid hydrogen.

### BRIEF DESCRIPTION OF THE FIGURES

The description which follows in light of the attached drawings, given as nonlimiting examples, will give a good understanding of what the invention consists of and how it can be produced. In the attached figures:

FIG. 1 schematically illustrates an example of configuration of a parking area equipped with a recharging system for electric batteries of motor vehicles according to a first possible embodiment of the invention;

FIG. 2 schematically illustrates the parking area of FIG. 1, equipped with a battery recharging system for electric batteries of motor vehicles according to a second possible embodiment of the invention;

FIG. 3 schematically illustrates the parking area of FIG. 1, equipped with a battery recharging system for electric batteries of motor vehicles according to a third possible embodiment of the invention;

FIG. 4 schematically illustrates another example of configuration of a parking area equipped with a recharging system for electric batteries of motor vehicles according to a first possible embodiment of the invention.

### DESCRIPTION OF EMBODIMENT(S)

In the figures, the elements that are identical or equivalent will bear the same reference symbols. The various diagrams are not to scale.

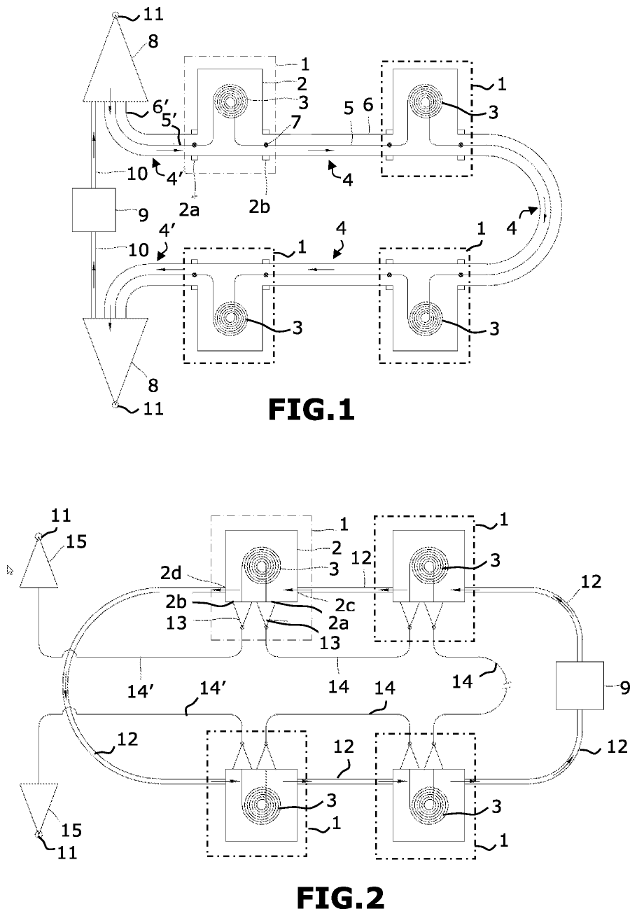

FIG. 1 illustrates a first possible embodiment of a recharging system according to the invention, with which a parking area is equipped, comprising, as a nonlimiting example, four parking locations 1 each intended to accommodate a motor vehicle (not represented) for a wireless recharging of the electric battery of this vehicle. The relative position of the parking locations 1 is unimportant with respect to the principles of the invention. The recharging system comprises, at each parking location 1, a cryogenic enclosure 2 enclosing a superconducting coil 3. Each cryogenic enclosure 2 is preferably buried to a short distance in the ground so that each superconducting coil 3 is oriented substantially horizontally, so as to be able to face and allow a good electromagnetic coupling with a recharging coil with which each electric vehicle is equipped. Each superconducting coil 3 can be composed of a winding of a superconducting wire, or of a winding of any superconducting element comprising a metal core (for example made of copper) surrounded by at least one superconducting layer, formed for example by several wires or tapes. The wires or tapes are for example made of a high-temperature superconducting (HTS) material operating in liquid nitrogen, but other superconducting materials, for example MgB2, can be provided without departing from the framework of the invention.

Each cryogenic enclosure 2 further comprises an input opening 2a for the passage of a first end of the superconducting coil 3 and an output opening 2b for the passage of the second end of the superconducting coil 3.

The recharging system further comprises intermediate portions 4 of superconducting cable for electrically connecting the different superconducting coils 3 in series. In the nonlimiting example of FIG. 1, three intermediate portions 4 of superconducting cable are necessary to connect the four superconducting coils 3 in series. Each intermediate portion 4 of superconducting cable comprises a core or a conductor 5 of superconducting cable which is contained in a dedicated cryogenic jacket 6. The dedicated cryogenic jacket 6 is, here, advantageously flexible, for example produced in a corrugated stainless steel. The ends of each intermediate portion 4 of superconducting cable are connected respectively at an output opening 2b and an input opening 2a of two consecutive cryogenic enclosures 2 of the set of the coils in series so as, on the one hand, to ensure a seal-tight continuity in the cryogenic cooling circuit, and, on the other hand, to allow the electrical connection of the conductor 5 to the ends of the two coils 3 contained in these two consecutive cryogenic enclosures 2. The reference 7 in FIG. 1 illustrates a point of electrical connection between an output end of a superconducting coil 3 and an end of a conductor 5.

The recharging system further comprises two terminations 8 configured to allow both the thermal transition between the cryogenic temperature and the ambient temperature and the transmission of voltage/current with the electrical network or any other external electrical source. One of the two terminations 8 is thus connected, as can be seen in FIG. 1, to the input 2a of the first cryogenic enclosure 2 of the series, while the other termination is connected to the output of the last cryogenic enclosure 2 of the series. In the nonlimiting embodiment illustrated, the connection of each termination 8 with the corresponding cryogenic enclosure 2 is preferably produced by means of end portions 4′ of superconducting cable, each comprising, like the intermediate portions 4 of superconducting cable connecting the cryogenic enclosures 2 pairwise, a superconducting conductor 5′ surrounded by a dedicated cryogenic jacket 6′, preferably flexible.

The recharging system also comprises a cryogenic cooling system 9 and two cryogenic transfer lines 10 linking the cryogenic cooling system 9 to each termination 8. The cryogenic cooling system 9 makes it possible to inject and circulate a cryogenic fluid throughout the recharging system, according to the flow of circulation indicated by the arrows, to ensure a cryogenic temperature that is compatible with the superconducting state. The cryogenic fluid is preferentially liquid nitrogen, but other cryogenic fluids could be provided (liquid hydrogen, supercooled gaseous helium, etc.). The cryogenic cooling system 9 can be in a closed loop. In this case, the cryogenic fluid is injected at the right temperature at one end, circulates throughout the loop and returns to the cooling by the second end to be cooled once again (for example by a cold head that is not represented) and reinjected. In a variant that is not represented, the cryogenic cooling system 9 can also be a system without new cooling of the cryogenic fluid, simply connected to a storage tank which must be filled from time to time (this is then called an open system).

As in the case of the cryogenic enclosures 2, the intermediate 4 and end 4′ portions of superconducting cable, the cooling system 9 and the cryogenic transfer lines 10 are preferably buried in the ground of the parking area. The terminations 8 are preferably not buried and situated at a certain distance from the earth to allow a totally safe connection to the electrical network.

In operation, the two terminations 8 are linked by two terminals 11 to an electrical power supply (not represented), which allows an injection of the current and of the voltage into the recharging system. This power supply is coupled to (or includes) any power equipment item that makes it possible to obtain the current value, the frequency value and the voltage value that are expected and suited to the operation of the recharging system. Any electric vehicle equipped with an electromagnetic energy harvesting coil can consequently recharge its battery by being placed correctly above one of the superconducting coils 3 of the recharging system.

The recharging system according to the embodiment illustrated in FIG. 1 is entirely superconducting and makes it possible, in a same looped circuit, to produce the circulation of cryogenic fluid and the electrical powering of the assembly composed of the series connection of the different superconducting coils 3. In other words, the recharging system here combines the electric circuit making it possible to power all of the superconducting coils 3 connected in series and the cryogenic fluid cooling circuit necessary to the correct operation of these superconducting coils 3. The electric circuit comprises the terminations 8, the superconducting conductors 5 and 5′ and the superconducting coils linked in series between the terminals 11. The cooling circuit comprises, for its part, the fluidic series connection of the terminations 8, of the dedicated cryogenic jackets 6, 6′ of the two end portions 4′ and of the intermediate portions 4 of superconducting cable, of the cryogenic enclosures 2, of the transfer lines 10 and of the cooling system 9. Such a totally superconducting arrangement makes it possible to reduce to the minimum the losses by Joules effect during the transmission of the energy, even if the number of coils is high and if the portions 4 and 4′ of superconducting cable are long.

FIG. 2 illustrates a second possible embodiment of a recharging system according to the invention, with which a parking area is equipped, similar to that of FIG. 1, comprising, as a nonlimiting example, four parking locations 1 each intended to accommodate an electric vehicle (not represented) for a wireless recharging of the electric battery of this vehicle. In this second embodiment, there are the four superconducting coils 3 in their respective cryogenic enclosures 2. Here however, the cryogenic fluid cooling circuit is independent of the electric circuit allowing the series connection of the different superconducting coils, for the portions of circuits external to the enclosures. This results in the following adaptations compared to the recharging system of FIG. 1:

Each cryogenic enclosure 2 still comprises an input opening 2a for the passage of a first end of the superconducting coil 3 that it encloses and an output opening 2b for the passage of the second end of the superconducting coil 3.

Differently however, each cryogenic enclosure 2 comprises a second input opening 2c and a second output opening 2d that are dedicated solely to the circulation of a cryogenic fluid according to a closed loop. Here, the recharging system thus comprises cryogenic transfer lines 12, five of them in the nonlimiting example illustrated in FIG. 2, three of which are capable of linking the different cryogenic enclosures 2 pairwise. Thus, in the nonlimiting example illustrated, three cryogenic transfer lines 12 have one end connected to an output opening of a cryogenic enclosure 2, and another end connected to an input opening of another cryogenic enclosure 2, one cryogenic transfer line 12 has one end connected to an output opening of a cryogenic enclosure 2 and another end connected at the input of a cryogenic cooling system 9, and one cryogenic transfer line 12 has one end connected at the output of the cryogenic cooling system 9 and another end connected to an input opening of a cryogenic enclosure 2.

Furthermore, the series connection and the electrical powering of the superconducting loops 3 are performed, according to the second embodiment, by an electric circuit independent of the cooling circuit, the electric circuit comprising:
dedicated pairs of intermediate electric terminations 13, preferably included at each cryogenic enclosure 2, each termination of a same pair receiving an end of the superconducting coil 3 of the corresponding cryogenic enclosure 2;
intermediate portions 14 of conventional cable (unlike the superconducting cables), comprising for example only a core made of copper, for electrically connecting the different superconducting coils 3 in series. In the nonlimiting example of FIG. 2, three intermediate portions 14 of conventional electric cable are necessary to connect the four superconducting coils 3 in series, via electrical terminations 13;
two conventional terminations 15 (replacing the terminations 8 of FIG. 1), each provided with a connection terminal 11 for connecting to an electrical power supply (not represented), which allows an injection of current and voltage into the recharging system. One of the two terminations 15 is thus connected, as can be seen in FIG. 2, to one of the terminations 13 of the pair of terminations of the first cryogenic enclosure 2 of the series, while the other termination 15 is connected to one of the terminations 13 of the pair of terminations 13 of the last cryogenic enclosure 2 of the series.
two end portions 14′ of conventional cable for the electrical connection of the first and last superconducting coils 13 with each of the conventional terminations 15.

Compared to the system according to the first embodiment described with reference to FIG. 1, one benefit of the system illustrated in FIG. 2 is that it requires a lesser volume of cryogenic fluid and a simpler cooling system 9.

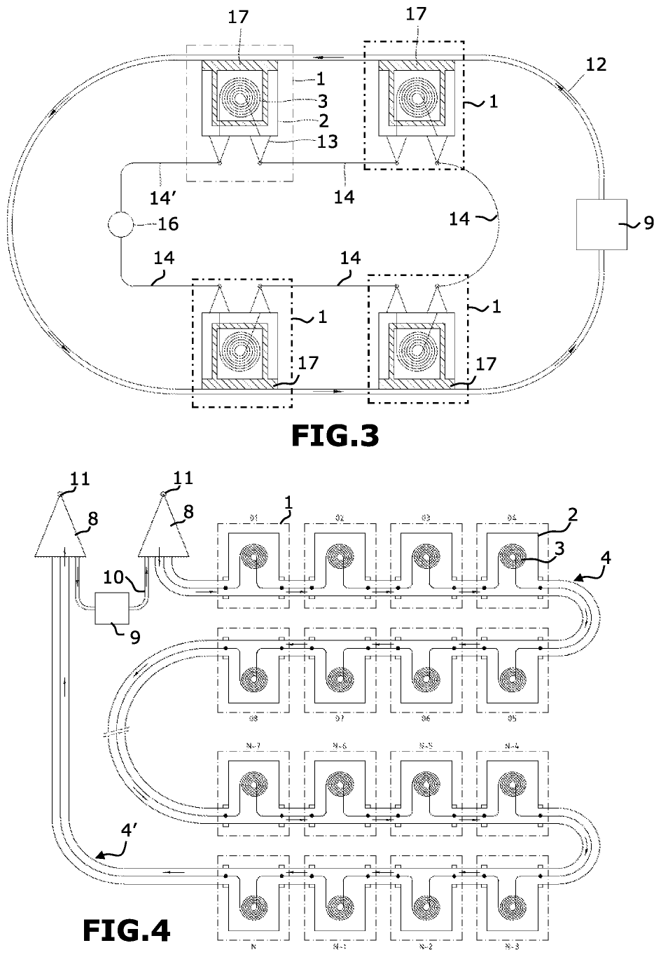

A third embodiment of an electric recharging system is represented in FIG. 3, with which a parking area is equipped, of the same type as that described previously, namely comprising, as a nonlimiting example, four parking locations 1. In this third embodiment, the electric circuit is totally independent of the cooling circuit. More specifically, this electric circuit is composed, as in the case of FIG. 2, of the four superconducting coils 3 connected in series pairwise using three intermediate portions 14 of conventional cable, the series assembly being connected to an electrical power supply 16 by means of two end portions 14′ of conventional cable. On the other hand, as can be seen in FIG. 3, the cryogenic fluid cooling circuit no longer passes through the interior of the enclosures 2. Differently, the cooling circuit comprises a cryogenic transfer line 12 whose ends are linked at the input and output of the cryogenic cooling system 9, so as to create a closed loop. The cryogenic transfer line 12 is disposed so as to be in contact with at least a portion of an element 17 made of thermally conductive material, for example copper, included in each enclosure 2. The superconducting coils 3 are therefore here cooled solely by thermal conduction. The quantity of cryogenic fluid necessary in this third embodiment is even smaller than in the second embodiment.

A recharging system according to any one of the three embodiments described hereinabove can include any number N of superconducting coils to allow the recharging of a corresponding number N of vehicles. FIG. 4 illustrates a possible configuration for a parking area comprising N parking locations 1, with a recharging system according to the first embodiment.

The use of superconducting coils connected in series by superconducting cables (FIGS. 1 and 4) or standard cables (FIGS. 2 and 3) to form a complete system comprising several charging points offers several advantages:
no electrical loss by Joules effect in the superconducting parts during the operation of the system, which results in a reduction of the operating costs linked to the circulation of the current.
a higher local magnetic field is generated for the wireless recharging, which leads to a better efficiency for the transmission of the energy to the car (efficiency greater than 97% with this superconducting technology, compared to a maximum efficiency of 90% for the prototype systems currently being developed with conventional conductors).
the superconductivity allows a compactness of the coils (higher current density).
the superconductivity allows a system with high current; therefore, for a given power, it leads to a lower operating voltage. Conventional solutions of large size have been studied up to 500 KW: with superconducting coils, they can be for example 1000 A coils powered by a 500 V source.
in the fully superconductive version according to the first embodiment, there is no thermal impact from the system if it is buried, for example under the surface of a car park, contrary to a conventional system which could generate thermal disturbances for closed water ducts or other conventional buried cables.
a cryogenic fluid such as liquid nitrogen has no impact on the environment (nitrogen constitutes the greatest portion of the atmosphere). However, with the emergence of hydrogen for the development of renewable energies, this other cryogen could also be an interesting alternative (liquid hydrogen as “energy storage” medium, circulation of liquid hydrogen between two points of the town, etc.).

The typical areas of interest for a recharging system according to the invention are large parking areas, large recharging stations along a very busy highway (fast recharging of a large number of vehicles at the same time), or the places where several vehicles must be fully recharged in a limited time (hospitals, police stations, etc.).

1. A system for wirelessly recharging electric batteries of motor vehicles suitable for equipping a parking area, the recharging system comprising:
a plurality of enclosures each comprising a superconducting coil, each enclosure being configured to be positioned at a parking location (1) of said parking area and comprising an input opening and an output opening for the respective passage of the ends of the superconducting coil that said each enclosure contains;
an electric circuit comprising intermediate portions of cable electrically connecting the superconducting coils pairwise so as to form a set of superconducting coils in series, two cable terminations, two cable end portions configured to electrically connect each end of the set to the terminals of an electrical power supply; and
a cooling circuit suitable for cooling each superconducting coil using a circulation of a cryogenic fluid.

2. The recharging system as claimed in claim 1, wherein each enclosure of the plurality of enclosures is a cryogenic enclosure.

3. The recharging system as claimed in claim 2, wherein the intermediate cable portions and the cable end portions are superconducting, and each comprise a superconducting conductor contained in a dedicated cryogenic jacket.

4. The recharging system as claimed in claim 3, wherein the dedicated cryogenic jacket is flexible.

5. The recharging system as claimed in claim 3, wherein the ends of each intermediate portion of superconducting cable are connected respectively at an output opening and an input opening of two consecutive cryogenic enclosures of the set of superconducting coils in series so as, on the one hand, to ensure a seal-tight continuity in the cryogenic cooling circuit, and, on the other hand, to allow the electrical connection of the superconducting conductor to the ends of the two superconducting coils contained in these two consecutive cryogenic enclosures.

6. The recharging system as claimed in claim 3, wherein the cooling circuit comprises the series fluidic connection of the two cable terminations, of the dedicated cryogenic jackets of the two end portions and of the intermediate portions of superconducting cable, and of the cryogenic enclosures.

7. The recharging system as claimed in claim 6, wherein the cooling circuit further comprises a cooling system and two transfer lines linking each termination to the cooling system.

8. The recharging system as claimed in claim 2, wherein each cryogenic enclosure of the plurality of enclosures comprises an input opening and an output opening for the cryogenic fluid, the cooling circuit comprising the fluidic series connection of a cooling system and of the cryogenic enclosures via cryogenic transfer lines.

9. The recharging system as claimed in claim 8, wherein the cryogenic transfer lines linking two cryogenic enclosures are connected between their input opening and their output opening for the respective cryogenic fluid.

10. The recharging system as claimed in claim 1, wherein each enclosure of the plurality of enclosures comprises an element made of thermally conductive material, and the cooling circuit comprises a cryogenic transfer line connected to a cryogenic cooling system so as to create a closed loop, the cryogenic transfer line being disposed so as to be in contact with said element of each enclosure to cool each superconducting coil by thermal conduction.

11. The recharging system as claimed in claim 8, wherein the intermediate portions of cable and the cable end portions each comprise a standard electrical conductor.

12. The recharging system as claimed in claim 11, wherein the ends of each intermediate portion of cable are connected respectively at an output opening and an input opening of two consecutive enclosures of the set of superconducting coils in series so as to allow the electrical connection of the standard electrical conductor to the ends of the two coils contained in these two consecutive enclosures.

13. The recharging system as claimed in claim 1, wherein the cryogenic fluid is liquid nitrogen.
